(19) United States
(12) Patent Application Publication
(10) Pub. No.: US 2020/0246644 A1
(43) Pub. Date: Aug. 6, 2020

(54) EMERGENCY FITTING APPARATUS

(71) Applicants: John Parker, Suffolk, VA (US); Joshua Mullen, Gloucester, VA (US)

(72) Inventors: John Parker, Suffolk, VA (US); Joshua Mullen, Gloucester, VA (US)

(21) Appl. No.: 16/783,088

(22) Filed: Feb. 5, 2020

Related U.S. Application Data
(60) Provisional application No. 62/801,606, filed on Feb. 5, 2019.

(51) Int. Cl. A62B 9/04; A62B 9/02

(52) U.S. Cl. CPC A62B 9/04; A62B 9/02

(57) ABSTRACT

An emergency fitting apparatus including a fitting body member having a first end and an opposing second end, a first port disposed at the first end of the fitting body member and formed to mount to a high-pressure compressor, a second port disposed at the second end of the fitting body member and formed to mount to a high-pressure flask, and a third port disposed between the first and second ports and formed to detachably mount to at least one self-contained breathing apparatus (SCBA) air cylinder.

### BACKGROUND OF THE INVENTION

### 1. Field of the Invention

The present general inventive concept relates to fittings, and more particularly, to a lifesaving, emergency fitting configured and formed to provide pressurized air to high pressure air systems using standard self-contained breathing apparatus (SCBA) air cylinders.

### 2. Description of Related Art

Many types of fittings have been previously developed for various high pressure applications. However, there are no conventional fittings or devices that provide a means to perform an emergency charging of an air flask in situations where any failure of a high pressure air compressor would render the entire starting air flask system useless after the air has been depleted.

Therefore, what is desired is an alternative means for achieving a sufficient air pressure in various high-pressure air systems, including starting air banks to allow restart on engines following a failure of a compressor, by using standard self-contained breathing apparatus (SCBA) air cylinders or the like.

### SUMMARY OF THE INVENTION

The present general inventive concept provides a lifesaving emergency fitting that is designed and configured to provide a means in charging starting air flasks in emergency situations. By pressurizing air flasks through the high pressure air charging bank using standard self-contained breathing apparatus air cylinders and or emergency breathing air compressor to provide starting air to diesel or gas turbine engine when high pressure air compressor has suffered a casualty. Allowing restoration of vessels primary or emergency power plant, restoring vital systems throughout the ship in casualty situations.

The emergency fitting according to the present general inventive concept may allow a user to pressurize air flasks through high pressure air charging banks using standard SCBA air cylinders and/or emergency breathing air compressors to provide starting air to diesel or gas turbine engines, when the high pressure air compressor fails.

Aspect and/or features of the present general inventive concept is achieved by providing an emergency fitting apparatus including a fitting body member having a first end and an opposing second end, a first port disposed at the first end of the fitting body member and formed to mount to a high-pressure compressor, a second port disposed at the second end of the fitting body member and formed to mount to a high-pressure flask and a third port disposed between the first and second ports and formed to detachably mount to at least one self-contained breathing apparatus (SCBA) air cylinder.

The high-pressure flask mounted to the second port may be filled with air from the at least one SCBA air cylinder mounted to the third port. The third port may have an inner diameter D1 that is substantially similar to an outer diameter D2 of the SCBA air cylinder.

Aspect and/or features of the present general inventive concept may also be achieved by providing an emergency fitting apparatus including a fitting body member having a first end and an opposing second end, a first port disposed at the first end of the fitting body member and formed to mount to a high-pressure compressor, a second port disposed at the second end of the fitting body member and formed to mount to a high-pressure flask, and a third port disposed between the first and second ports and formed to detachably mount to at least one self-contained breathing apparatus (SCBA) air cylinder.

The high-pressure flask may be filled with air from the at least one SCBA air cylinder mounted to the third port though the second port.

The third port may have an inner diameter that is substantially similar to an outer diameter of the SCBA air cylinder.

Aspect and/or features of the present general inventive concept may also be achieved by providing a method of charging high-pressure flasks using a self-contained breathing apparatus air cylinder, the method includes providing a high-pressure compressor and a high-pressure flask, providing an emergency fitting apparatus including a fitting body member having a first end and an opposing second end, a first port disposed at the first end of the fitting body member and formed to mount to a high-pressure compressor, a second port disposed at the second end of the fitting body member and formed to mount to a high-pressure flask, and a third port disposed between the first and second ports and formed to detachably mount to at least one self-contained breathing apparatus (SCBA) air cylinder, mounting the first port of the emergency fitting apparatus to the high-pressure compressor, mounting the second port of the emergency fitting apparatus to the high-pressure flask, mounting the third port of the emergency fitting apparatus to the SCBA air cylinder, and charging the high-pressure flask with air from the SCBA air cylinder through the emergency fitting apparatus.

The method may further include mounting a first close off valve in between the high-pressure compressor and the first port and a second close-off valve in between the high-pressure flask and the second port.

The method may further include closing the first and second close-off valves. The method may further include detachably mounting a SCBA air cylinder to the third port. The method may further include opening the second close-off to fill the high-pressure flask with air from the SCBA air cylinder mounted to the third port through the emergency fitting apparatus.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 illustrates a front perspective view of an emergency fitting apparatus according to an exemplary embodiment of the present general inventive concept;

FIG. 2 is a top plan view of the emergency fitting apparatus illustrated in FIG. 1;

FIG. 3 is a front view of the emergency fitting apparatus illustrated in FIG. 1;

FIG. 4 is a cross-sectional view of the emergency fitting apparatus taken along line A-A in FIG. 2;

FIG. 5 is a front view of the emergency fitting apparatus illustrated in FIG. 1, wherein a flow path between the ports is shown in hidden lines; and

FIG. 6 is a schematic diagram illustrating an implementation of the emergency fitting apparatus illustrated in FIG. 1.

### DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

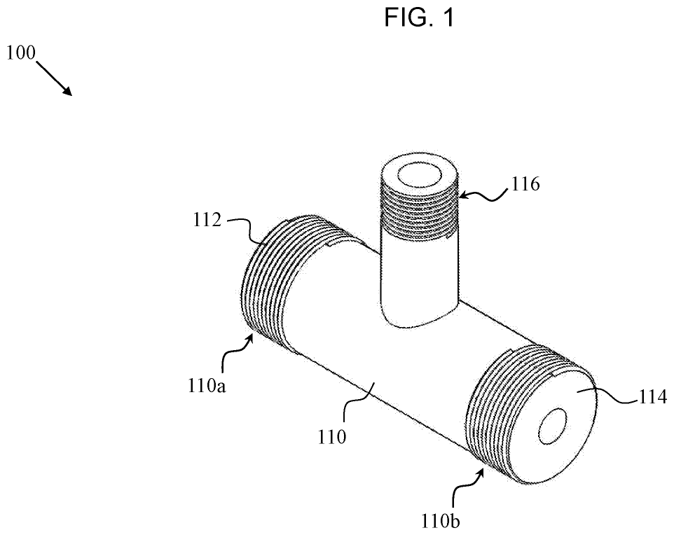

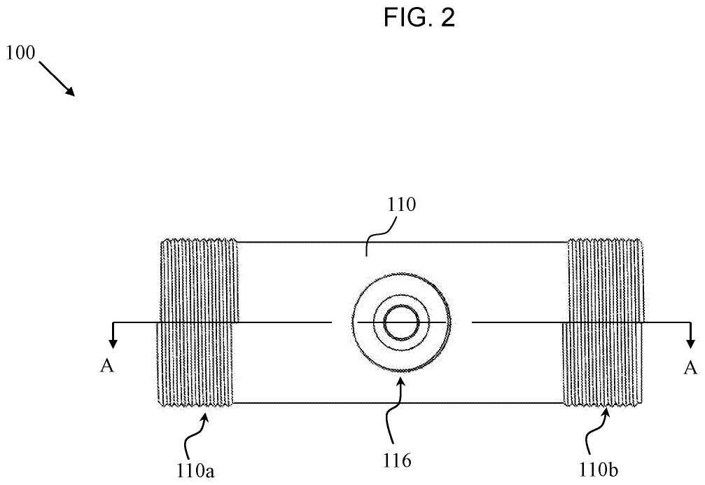

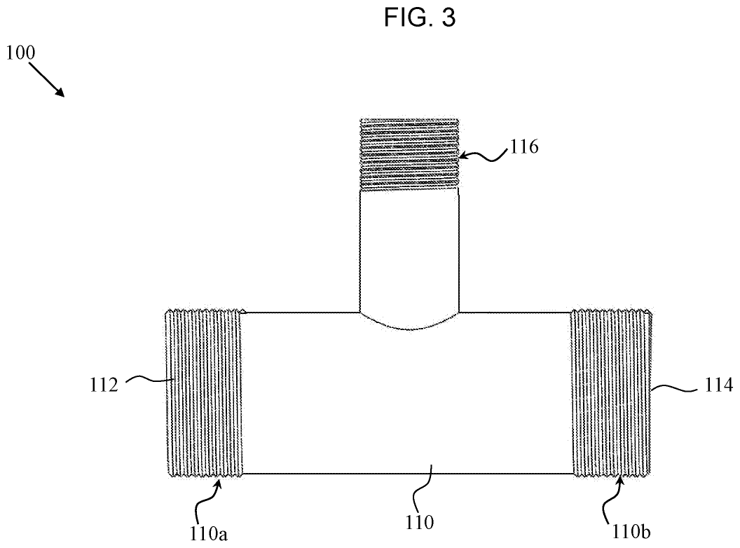

FIG. 1 illustrates a front perspective view of an emergency fitting apparatus 100 according to an exemplary embodiment of the present general inventive concept, FIG. 2 is a top plan view of the emergency fitting apparatus 100 illustrated in FIG. 1, and FIG. 3 is a front view of the emergency fitting apparatus 100 illustrated in FIG. 1.

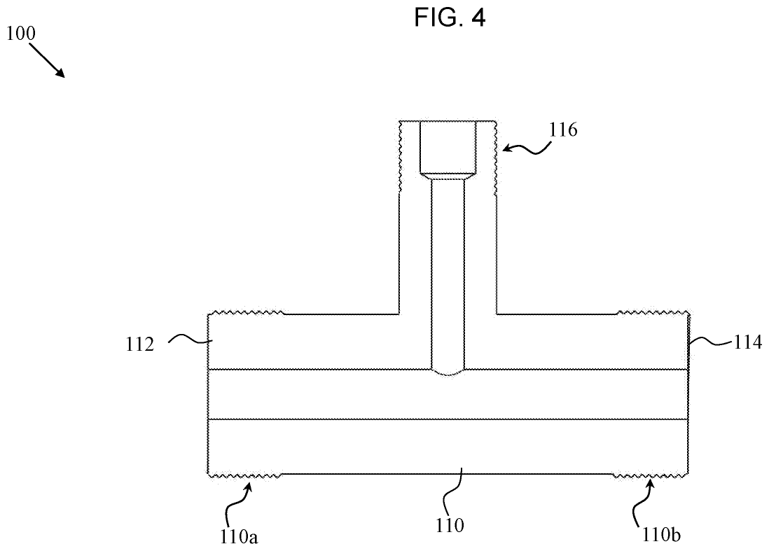

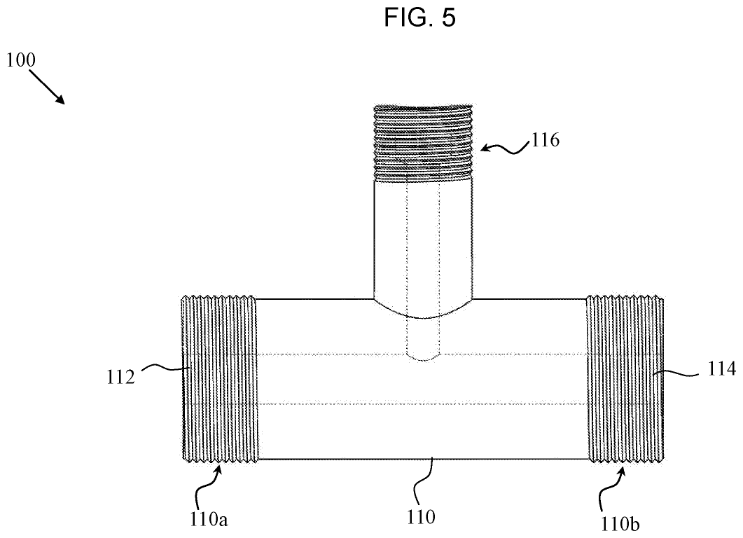

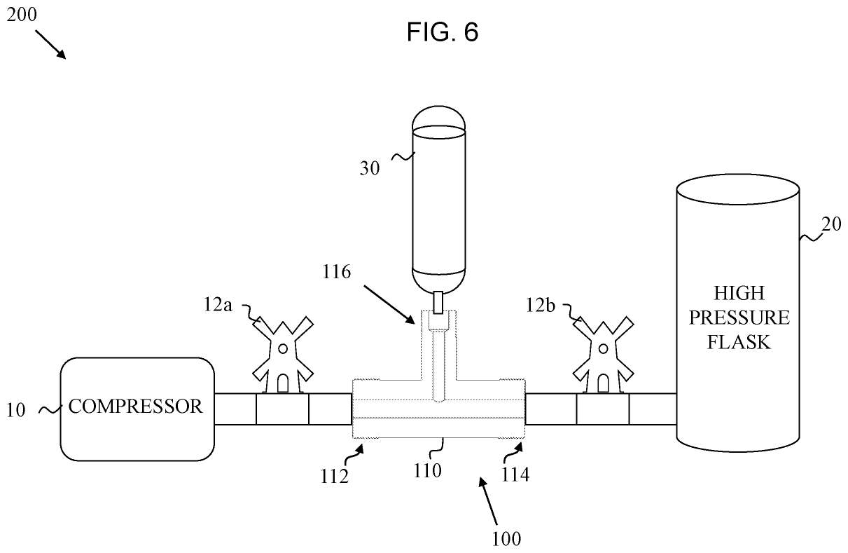

FIG. 4 is a cross-sectional view of the emergency fitting apparatus 100 taken along line A-A in FIG. 2, FIG. 5 is a front view of the emergency fitting apparatus 100 illustrated in FIG. 1, wherein a flow path between the ports is shown in hidden lines, and FIG. 6 is a schematic diagram illustrating an implementation of the emergency fitting apparatus 100 illustrated in FIG. 1.

Referring to FIGS. 1 through 3, the emergency fitting apparatus, designated generally as 100, is illustrated. The emergency fitting apparatus 100 includes a fitting body member 110 having a first port 112 disposed at a first end 110a, a second port 114 disposed at an opposing second end 110b, and a third 116 port disposed on the fitting body member 110 in between the first port 112 and the second port 114.

The first port 112 is formed to mount to a high-pressure compressor 10, the second port 114 is formed to mount to a high-pressure flask 20, and the third 116 port is formed to detachably mount to at least one air cylinder 30. However, the present general inventive concept is not limited thereto.

In alternative embodiments, the first port 112 is designed, configured, and formed to mount directly or indirectly to a high-pressure compressor 10. The first port 112 may include threads or various other connecting members or arrangements (e.g., a quick connect coupling) configured to securely mount onto a fitting in fluid communication with the high-pressure compressor 10. The first port 112 may be valve controlled to permit selective exposure of the air generated by the high-pressure compressor 10.

In alternative embodiments, the second port 114 is designed, configured, and formed to mount directly or indirectly to a high-pressure flask 20. The second port 114 may include threads or various other connecting members or arrangements (e.g., a quick connect coupling) configured to securely mount onto a fitting in fluid communication with the high-pressure flask 20. The second port 114 may be valve controlled to permit selective exposure of the air contained within the high-pressure flask 10.

In alternative embodiments, the third port 116 is designed, configured, and formed to detachably mount directly or indirectly to at least one air cylinder 30. The third port 116 may include threads or various other connecting members or arrangements (e.g., a quick connect coupling) configured to securely mount onto a fitting in fluid communication with the at least on SCBA air cylinder 30.

That is, in alternative embodiments, the third port 116 may be formed to detachably mount to a variety of conventional portable air cylinders 30, including a self-contained breathing apparatus (SCBA) air cylinder 30. The third port 116 may be valve controlled to permit selective release of the air contained within the SCBA air cylinder 30 to the high-pressure flask 20.

In the present embodiment, the fitting body member has a first end and an opposing second end. The emergency fitting apparatus 100 includes a first port disposed at the first end and a second port disposed at the second end. The first port is designed, configured, and formed to mount directly or indirectly to a high-pressure compressor. The second port is designed, configured, and formed to mount directly or indirectly to a high-pressure flask.

In the present embodiment, the fitting body member further includes a third port disposed in between the first port and the second port. The third port is designed, configured, and formed to detachably mount to at least one air cylinder, including the SCBA air cylinder.

Referring to FIG. 6, during use, the emergency fitting apparatus 100 is mounted in between a high-pressure compressor 10 and a high-pressure flask 20 using the first and second ports 112, 114, respectively.

In a non-limiting example of an emergency situation in which the high-pressure compressor 10 has failed, the high pressure flask 20 may be refilled using a variety of readily available air cylinders, including standard SCBA air cylinders 30, through the third port 116 of the emergency fitting apparatus 100. The high pressure flask 20 may be provided with air from the SCBA air cylinder 30.

The present general inventive concept further includes a method 200 of charging or filling high-pressure flasks 20 with air from self-contained breathing apparatus air cylinders 30 using the emergency fitting apparatus 100. The method includes providing a high-pressure compressor and a high-pressure flask and mounting an emergency fitting apparatus having a fitting body member having a first end and an opposing second end, a first port disposed at the first end of the fitting body member and formed to mount to a high-pressure compressor, a second port disposed at the second end of the fitting body member and formed to mount to a high-pressure flask, and a third port disposed between the first and second ports and formed to detachably mount to at least one self-contained breathing apparatus (SCBA) air cylinder.

Next, the method 200 includes mounting the first port of the emergency fitting apparatus to the high-pressure compressor and the second port of the emergency fitting apparatus to the high-pressure flask.

Next, during an emergency in which the high-pressure compressor 10 is no longer operational, mounting a SCBA air cylinder 30 to the third port 116 of the emergency fitting apparatus 100.

Finally, the high-pressure flask with air from the SCBA air cylinder 30 through the emergency fitting apparatus 100.

In alternative embodiments, the method 200 may further include mounting a first close-off valve 12a in between the high-pressure compressor 10 and the first port 112 and a second close-off valve 12b in between the high-pressure flask 20 and the second port 114.

In further alternative embodiments, the method 200 may further include detachably mounting a SCBA air cylinder 30 to the third port 116 of the emergency fitting apparatus 100.

In yet further alternative embodiments, the method 200 may further include closing the first close-off valve 12a to the high pressure air compressor 10 and opening the second close-off valve 12b to fill the high-pressure flask 20 with air from the SCBA air cylinder 30 mounted to the third port 116 of the emergency fitting apparatus 100.

It is desired that all components of the emergency fitting apparatus 100 be formed of robust and durable materials capable of withstanding repeated use under elevated pressures and temperatures, as required for various applications.

In use, the emergency fitting apparatus is designed to provide an emergency means for achieving sufficient air pressure in various high pressure air systems, including starting air banks or flasks to allow restart on engines following a failure of a high pressure compressor by using self-contained breathing apparatus (SCBA) air cylinders.

The emergency fitting apparatus includes a first port disposed at a first end of the fitting body member and formed to mount to a high-pressure compressor, a second port disposed at a second end of the fitting body member and formed to mount to a high-pressure flask and a third port disposed between the first and second ports and formed to detachably mount to at least one self-contained breathing apparatus (SCBA) air cylinder.

That is, the emergency fitting apparatus is specifically designed and configured to be installed in high pressure air charging banks for a starting high-pressure air flask, by removing the charging bank valve and installing the emergency fitting apparatus in its place. Air is delivered by using emergency breathing air compressor and/or various other standard self contained breathing apparatus air cylinders attached to the third port using standard self contained breathing apparatus air cylinder charging hose and connections until a sufficient pressure is reached in high-pressure air flasks to start an engine, for instance. However, the present general inventive concept is not limited thereto.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An emergency fitting apparatus comprising:
a fitting body member having a first end and an opposing second end;
a first port disposed at the first end of the fitting body member and formed to mount to a high-pressure compressor;
a second port disposed at the second end of the fitting body member and formed to mount to a high-pressure flask; and
a third port disposed between the first and second ports and formed to detachably mount to at least one self-contained breathing apparatus (SCBA) air cylinder.

2. The claim 1, wherein the high-pressure flask is filled with air from the at least one SCBA air cylinder mounted to the third port though the second port.

3. The claim 1, wherein the third port has an inner diameter that is substantially similar to an outer diameter of the SCBA air cylinder.

4. A method of charging high-pressure flasks using a self-contained breathing apparatus air cylinder, the method comprising:
providing a high-pressure compressor and a high-pressure flask;
providing an emergency fitting apparatus comprising:
a fitting body member having a first end and an opposing second end;
a first port disposed at the first end of the fitting body member and formed to mount to a high-pressure compressor;
a second port disposed at the second end of the fitting body member and formed to mount to a high-pressure flask; and
a third port disposed between the first and second ports and formed to detachably mount to at least one self-contained breathing apparatus (SCBA) air cylinder;
mounting the first port of the emergency fitting apparatus to the high-pressure compressor;
mounting the second port of the emergency fitting apparatus to the high-pressure flask;
mounting the third port of the emergency fitting apparatus to the SCBA air cylinder; and
charging the high-pressure flask with air from the SCBA air cylinder through the emergency fitting apparatus.

5. A method of claim 4, further comprising mounting a first close off valve in between the high-pressure compressor and the first port and a second close-off valve in between the high-pressure flask and the second port.

6. A method of claim 5, further comprising closing the first and second close-off valves.

7. A method of claim 6, further comprising detachably mounting a SCBA air cylinder to the third port.

8. A method of claim 7, further comprising opening the second close-off to fill the high-pressure flask with air from the SCBA air cylinder mounted to the third port through the emergency fitting apparatus.
